(19) United States
(12) Patent Application Publication
(10) Pub. No.: US 2021/0178532 A1
(43) Pub. Date: Jun. 17, 2021

(54) METHOD OF DISMANTLING TOWER-TYPE WIND POWER GENERATION FACILITY

(71) Applicant: BESTERRA CO., LTD., Tokyo (JP)

(72) Inventors: Yoshihide YOSHINO, Tokyo (JP); Yoshiaki AOKI, Tokyo (JP)

(73) Assignee: BESTERRA CO., LTD., Tokyo (JP)

(21) Appl. No.: 16/771,057

(22) PCT Filed: Dec. 14, 2017
(86) PCT No.: PCT/JP2017/044942

§ 371 Date: Jun. 9, 2020

(51) Int. Cl. B23P 19/04; F03D 13/10; F03D 13/20

(52) U.S. Cl. CPC B23P 19/04; F03D 13/10; F05B 2230/61; F05B 2230/70; F03D 13/20

(57) ABSTRACT

A method for disassembling a tower-type wind power generation facility eliminates scaffolding to be set up on the periphery of a tower body. An inner tower of a tower crane is built in an inner hollow of a tower body to install a crane apparatus at an upper end part, a nacelle and a wind power generator at an upper end part of the tower body are disassembled, the resulting disassembled objects are lowered through the outside of the tower body using the crane apparatus of the tower crane in the tower body, a working stage is provided on the inner tower after the wind power generator is disassembled, the tower body is disassembled via this stage provided on the inner tower, and the disassembled objects are lowered through the outside of the tower body using the crane apparatus of the tower crane.

### TECHNICAL FIELD

The present invention relates to a method for disassembling a wind power generation facility, in particular, a method for disassembling a tower-type wind power generation facility.

### BACKGROUND ART

In many cases, for example, as disclosed in Patent Literature 1 below, tower-type wind power generation facilities include a wind power generator at the upper end part of a tower body. Moreover, the interior of the tower body is often hollow. In order to pursue the efficiency of wind power generation, tower-type wind power generation facilities of this type are constructed at various sites such as ones on mountains, and off land (ocean) ones.

The lives of tower-type wind power generation facilities of this sort are regarded as 20-30 years (service life thereof in Japan is 17 years). Similarly to other power generation facilities, tower-type wind power generation facilities having reached their lives or service life are to be disassembled. In a conventional method for disassembling a tower-type wind power generation facility, scaffolding is set up on the whole periphery outside the tower body similarly to a constructing method in construction thereof, and the wind power generator and the tower body are disassembled using the scaffolding. A crane which is provided on the scaffolding or a movable crane is used when disassembled objects are lowered.

### PRIOR ART LITERATURE

### Patent Literature

Patent Literature 1: Japanese Patent Laid-Open No. 2012-102692

### SUMMARY OF INVENTION

### Problems to be solved by the Invention

Work to set up huge scaffolding on the whole periphery outside the huge tower body, however, is complicated and forcibly leads to work at a high place for a long time since a tower-type wind power generation facility is generally huge and typically needs work at a windy place. Accordingly, the period of disassembling operation of a tower-type wind power generation facility problematically tends to increase, and consequently, tends to increase costs of the disassembling operation. Moreover, in the first place, an off land wind power generation facility or the like causes a situation difficult in setting up sufficient scaffolding.

The present invention is devised in view of the aforementioned problems, and an object thereof is to provide a method for disassembling a tower-type wind power generation facility which method eliminates scaffolding to be set up on the periphery of a tower body and can simplify disassembling operation as a whole and reduce the period of the disassembling operation.

### Means for Solving the Problems

In order to achieve the aforementioned object, a method for disassembling a tower-type wind power generation facility according to claim 1 is a method for disassembling a tower-type wind power generation facility including a tower body having an inner hollow communicating in an up-down direction, and a wind power generator provided at an upper end part of the tower body, the method including: an inner tower building step of building, in the inner hollow of the tower body, an inner tower that penetrates from a region of a lower end part of the tower body to an upper portion of the power generation facility and that a crane apparatus is able to be mounted on; a crane installing step of installing the crane apparatus on the inner tower; a wind power generator disassembling step of disassembling a structure object of the wind power generator at the upper end part of the tower body to lower a resulting disassembled object through an outside of the tower body with the crane apparatus; a working stage installing step of providing, in midterm of or after the steps, a stage for disassembling work on the inner tower; and a tower body disassembling step of disassembling the tower body using the stage sequentially from its upper part to lower a resulting disassembled object through the outside of the tower body with the crane apparatus.

According to this configuration, since the crane apparatus can be installed on the inner tower built in the inner hollow of the tower body, the disassembled object of the structure object of the wind power generator at the upper end part of the tower body can be lowered through the outside of the tower body using the crane apparatus, the tower body can be disassembled, after the wind power generator is disassembled, from its inside via the stage provided on the inner tower, and the resulting disassembled object can be lowered through the outside of the tower body using the crane apparatus, huge scaffolding does not need to be set up on the whole periphery outside the huge tower body. Moreover, since lifting and lowering the stage in accordance with the disassembling position of the tower body makes the disassembling work of the tower body easy, this can reduce the period of the disassembling operation of the tower-type wind power generation facility and can simplify the disassembling operation itself, which can consequently reduce costs of the disassembling operation of the tower-type wind power generation facility as a whole. Moreover, even for an off land tower-type wind power generation facility or the like that sufficient scaffolding cannot be set up on the periphery of the tower body, since the inner tower can be built using the inner hollow of the tower body and the power generation facility can be disassembled using the crane apparatus installed on the inner tower, disassembling operation can be securely performed for various tower-type wind power generation facilities.

The invention according to claim 2 is the method for disassembling a tower-type wind power generation facility according to claim 1, wherein the installation of the stage in the working stage installing step is performed such that the stage extends in a horizontal direction on a periphery of the inner tower in the inner hollow of the tower body and is performed such that the stage is able to be lifted and lowered along the inner tower.

According to this configuration, the tower body can be disassembled via the stage at various places at the same height, and therefore, by lifting and lowering the stage, the tower body can be disassembled sequentially from its upper part.

The invention according to claim 3 is the method for disassembling a tower-type wind power generation facility according to claim 2, wherein the working stage installing step includes adjusting a height position of the stage by the stage being lifted or lowered so as to meet a disassembling position in the tower body disassembling step.

According to this configuration, by increasing and decreasing the height position of the stage so as to meet the disassembling position of the tower body, the tower body can be disassembled via the stage safely and efficiently.

The invention according to claim 4 is the method for disassembling a tower-type wind power generation facility according to any one of claims 1 to 3, including a roof installing step of providing a roof on the inner tower between the crane apparatus and the stage.

Since this configuration can afford a shelter from rain (snow) on the stage, the disassembling operation of the tower-type wind power generation facility can be performed even in rainy weather or the like.

The invention according to claim 5 is the method for disassembling a tower-type wind power generation facility according to any one of claims 1 to 4, including, before the inner tower building step, a tower body upper part opening step of opening a wind power generator housing part at an upper end part of the tower body to penetrate in the up-down direction.

According to this configuration, by opening the wind power generator housing part which is generally closed and is at the upper end part of the tower body to penetrate in the up-down direction in advance, the inner tower can be built to penetrate the tower body to the upper portion.

The invention according to claim 6 is the method for disassembling a tower-type wind power generation facility according to any one of claims 1 to 5, including, before the inner tower building step, an opening part forming step of forming an opening part for carrying a facility in in a lower end part of the tower body.

According to this configuration, by carrying inner tower members and the crane apparatus in through the opening part for carrying a facility in, the inner tower can be easily built in the tower body and the crane apparatus can be easily installed (moved) onto the upper part of the inner tower.

The invention according to claim 7 is the method for disassembling a tower-type wind power generation facility according to any one of claims 1 to 6, wherein the inner tower building step and the crane installing step are performed using a mast climbing-type crane apparatus that climbs and descends the inner tower along the same while building the inner tower.

According to this configuration, the inner tower can be easily and securely built in the tower body and the crane apparatus can be easily and securely installed onto the upper part of the inner tower.

### Effects of Invention

According to the present invention as described above, since the crane apparatus can be installed on the inner tower built in the inner hollow of the tower body, the disassembled object of the structure object of the wind power generator at the upper end part of the tower body can be lowered through the outside of the tower body using the crane apparatus, the tower body can be disassembled, after the wind power generator is disassembled, from its inside via the stage provided on the inner tower, and the resulting disassembled object can be lowered through the outside of the tower body using the crane apparatus, huge scaffolding does not need to be set up on the whole periphery outside the huge tower body. Moreover, since lifting and lowering the stage in accordance with the disassembling position of the tower body makes the disassembling work of the tower body easy, this can reduce the period of the disassembling operation of the tower-type wind power generation facility and can simplify the disassembling operation itself, which can consequently reduce costs of the disassembling operation of the tower-type wind power generation facility as a whole. Furthermore, since the tower body is disassembled from the inside, wind scarcely affects the disassembling work. Moreover, even for an off land tower-type wind power generation facility or the like that sufficient scaffolding cannot be set up on the periphery of the tower body, since the inner tower can be built using the inner hollow of the tower body and the power generation facility can be disassembled using the crane apparatus installed on the inner tower, disassembling operation can be securely performed for various tower-type wind power generation facilities.

### BRIEF DESCRIPTION OF DRAWINGS

FIG. 1 is a partially sectional elevational view showing a schematic configuration of an embodiment of a tower-type wind power generation facility which is to be disassembled by a method for disassembling a tower-type wind power generation facility of the present invention.

FIG. 2 is an explanatory diagram of the method for disassembling a tower-type wind power generation facility in FIG. 1.

FIG. 3 is an explanatory diagram of the method for disassembling a tower-type wind power generation facility in FIG. 1.

FIG. 4 is an explanatory diagram of the method for disassembling a tower-type wind power generation facility in FIG. 1.

FIG. 5 is an explanatory diagram of the method for disassembling a tower-type wind power generation facility in FIG. 1.

FIG. 6 is a detailed explanatory diagram of a stage in FIG. 5

FIG. 7 is an explanatory diagram of the method for disassembling a tower-type wind power generation facility in FIG. 1.

FIG. 8 is an explanatory diagram of the method for disassembling a tower-type wind power generation facility in FIG. 1.

### MODE FOR CARRYING OUT THE INVENTION

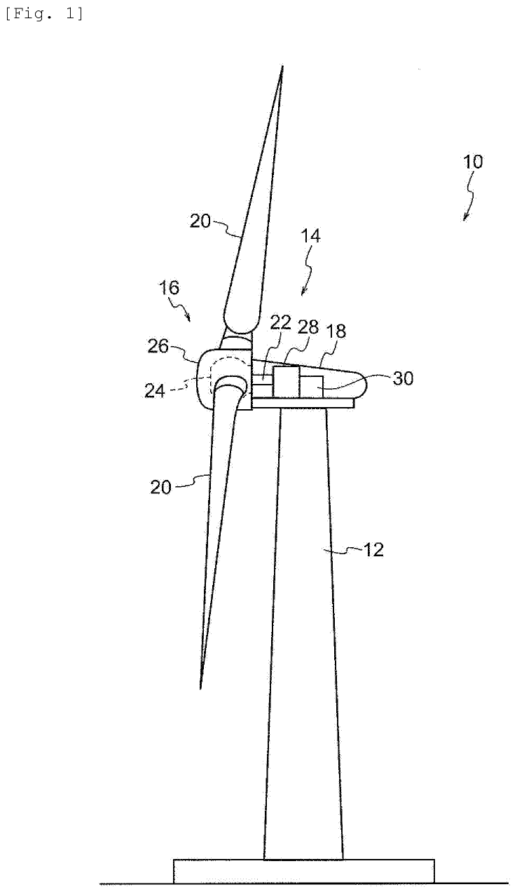

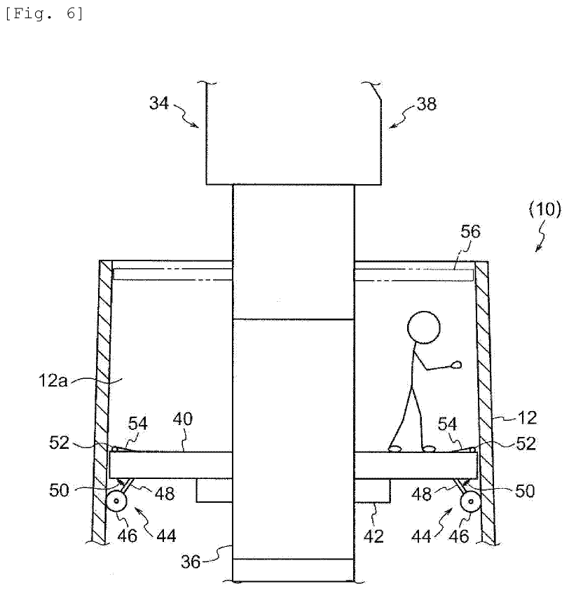

An embodiment of a method for disassembling a tower-type wind power generation facility of the present invention is hereafter described in detail with reference to the drawings. FIG. 1 is a partially sectional elevational view showing a state before disassembling a tower-type wind power generation facility 10 which is to be disassembled by this disassembling method of an embodiment. Similarly to an existing tower-type wind power generation facility, this tower-type wind power generation facility 10 includes a wind power generator 14 at an upper end part of a tower body 12, and in general, has a hollow 12a inside the tower body 12 (refer to FIG. 6). Not-shown spiral staircase, ladder and/or the like are provided in this inner hollow 12a of the tower body 12, for example, such that a person who maintains and inspects the wind power generator 14 can climb those. The height and the size of the tower body 12 vary, for example, depending on a site where the wind power generation facility is constructed, the height of the tower body 12 is occasionally 60 m or more for a ground wind power generation facility and 100 m or more for an off land (ocean) wind power generation facility, the outer diameter of the tower body 12 is 4 m or more at the lower end part thereof, and the diameter of the inner hollow 12a is 3 m or more at the top part of the tower body 12.

A rotor 16 and a nacelle 18 are provided at the top part of the tower body 12. The rotor 16 is a rotor of the wind power generator 14, and the nacelle 18 is a housing part (casing) housing main devices of the wind power generator 14. The rotor 16 is configured to include blades 20 constituting blades of a windmill, a hub 24 for connecting the blades 20 to a main shaft 22, and the like, and the hub 24 is covered by a rotor cover 26. In the nacelle 18, a transmission 28 which primarily increases the rotational speed of the main shaft 22, a generator 30 which generates electric power from the rotary shaft thus accelerated, and the like are housed. Moreover, a not-shown yaw adjusting apparatus which adjusts the orientation of the rotor 16, in other words, the yaw axis thereof by means of the whole nacelle 18, and the like are provided at the lower part of the nacelle 18. Moreover, a not-shown transformation apparatus which converts the electric power generated by the generator 30 into electric power suitable for a system, and the like are also arranged in the lower part of the tower body 12.

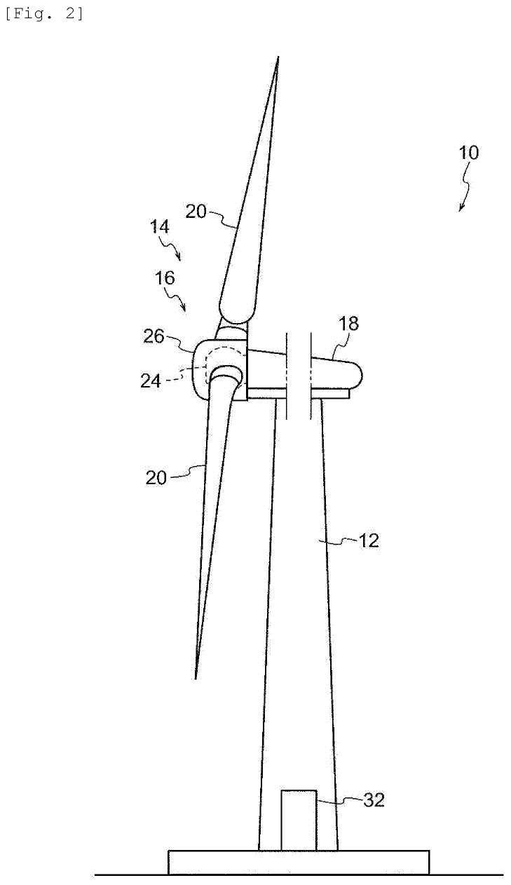

Since as mentioned above, the life of a tower-type wind power generation facility is 20-30 years and the service life thereof in Japan is 17 years, a tower-type wind power generation facility having reached its life or service life is to be disassembled. FIG. 2 shows a state before disassembling work of the tower-type wind power generation facility 10 is performed in this embodiment, and schematically shows the appearance of the tower body 12 and the inner state of the nacelle 18. In this work as a preparation for substantial disassembling operation, an opening part 32 for carrying facilities in is formed in the lower end part of the tower body 12 (opening part forming step). In the disassembling method of this embodiment, it is needed to carry inner tower members for a tower crane 34, a crane apparatus 38 itself, a stage 40 which is attached to an inner tower 36 and which persons get on, and the like in the inner hollow 12a of the tower body 12. Although the lower end part of the tower body 12 generally has some opening part (door) where a person can enter, it is difficult to carry such facilities (members for the facility) in therethrough, Therefore, the opening part 32 is formed in the size which can allow the facilities (members for the facility) to be carried in, and the periphery of the opening part 32 is reinforced as needed.

Moreover, this preparing work for disassembling opens the nacelle 18 provided at the upper end part of the tower body 12 to penetrate in the up-down direction (tower body upper part opening step). This is to extend the inner tower 36 for the tower crane 34 mentioned later to an upper portion above the tower-type wind power generation facility 10. Namely, since as mentioned later in detail, disassembled objects are lowered through the outside of the tower body 12 in the method for disassembling a tower-type wind power generation facility of this embodiment, the tower crane 34 needs to penetrate to an upper portion above the tower body 12, in other words, the upper portion above the tower-type wind power generation facility 10. Since the interior of the nacelle 18 is typically isolated from the outside, the upper end part of the tower body 12 is closed by the nacelle 18. Therefore, the nacelle 18 is opened to penetrate in the up-down direction. Since the crane apparatus 38 of mast climbing type as mentioned later is used in this embodiment, the opening parts of the nacelle 18 are set to have the size with which the crane apparatus 38 of this type can pass therethrough. Since as mentioned above, in some cases, the diameter of the inner hollow 12a at the top part of the tower body 12 is 3 m or more and the diameter size of the crane apparatus (pedestal portion) mentioned later is less than 3 m, the crane apparatus 38 can be installed at the upper portion above the tower-type wind power generation facility 10 when the crane apparatus 38 can pass through the opening parts of the nacelle 18. Notably, when facilities inside the nacelle 18 (mainly structure objects of the wind power generator) are obstructive against the penetration through the nacelle 18 in the up-down direction, they are removed or moved. Moreover, in this stage, a spiral staircase, a ladder and/or the like provided in the inner hollow 12a of the tower body 12 are removed.

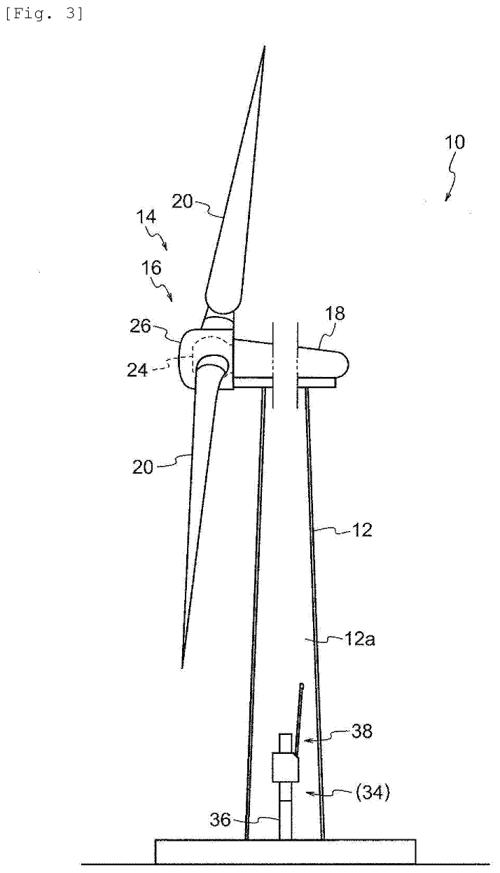

FIG. 3 shows an early state of starting disassembling operation, and schematically shows the inner states of both the tower body 12 and the nacelle 18. In the disassembling operation of this embodiment, first, the inner tower 36 for the tower crane 34 is built in the inner hollow 12a of the tower body 12 of the tower-type wind power generation facility 10 (inner tower building step). Various methods are used as a method for building this inner tower 36, and in this embodiment, the inner tower 36 is built using the tower crane 34 of so-called mast climbing type. As is well known, a mast climbing-type tower crane adds and fixes tower members to its upper portion by the crane apparatus itself to climb the tower (mast), and can also descend the tower of course. Therefore, the crane apparatus 38 of this embodiment has a not-shown lift apparatus including a locking bar which is inserted into the tower, a cylinder for lifting and lowering the crane apparatus 38 with the locking bar being as a support, and the like similarly to a known mast climbing-type crane apparatus. Moreover, also when disassembling the inner tower 36, the crane apparatus 38 itself lowers inner tower members resulting from the disassembling. The boom of the crane apparatus 38 can be put upright in the vertical direction by releasing its limiter. Notably, for this embodiment, the crane apparatus 38 means an apparatus capable of hoisting a load and lowering the load.

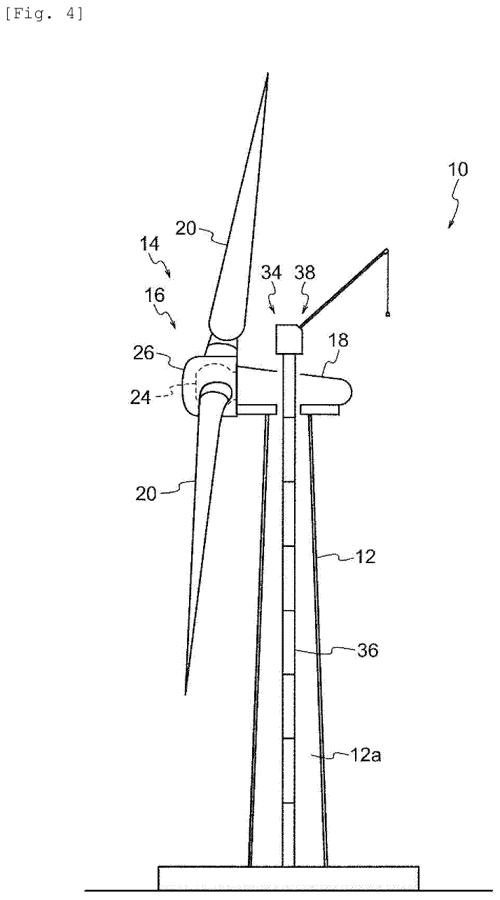

FIG. 4 shows a state where the inner tower 36 is built up to the upper portion above the tower-type wind power generation facility 10, and onto its upper end part, the crane apparatus 38 moves (the crane apparatus 38 is installed), and schematically shows the inner states of both the tower body 12 and the nacelle 18. After the inner tower 36 is built up to the upper portion above the tower-type wind power generation facility 10, and onto its upper end part, the crane apparatus 38 is arranged (crane apparatus installing step) as above, structure objects of the wind power generator 14 are disassembled inside the nacelle 18 or through the upper part of the nacelle 18 (wind power generator disassembling step). A tentative stage may be built for disassembling the structure objects of the wind power generator 14. In this disassembling of the structure objects of the wind power generator 14, for example, the blades 20 of the rotor 16 are removed from the hub 24, and then, the hub 24 and the main shaft 22 are removed. These disassembled objects are lowered downward through the outside of the tower body 12 using the crane apparatus 38. The equipment, of the wind power generator 14, arranged inside the nacelle 18 is also lowered downward through the outside of the tower body 12 using the crane apparatus 38. In the final stage, the nacelle 18 remaining is disassembled, and the resulting disassembled objects are lowered downward through the outside of the tower body 12 using the crane apparatus 38.

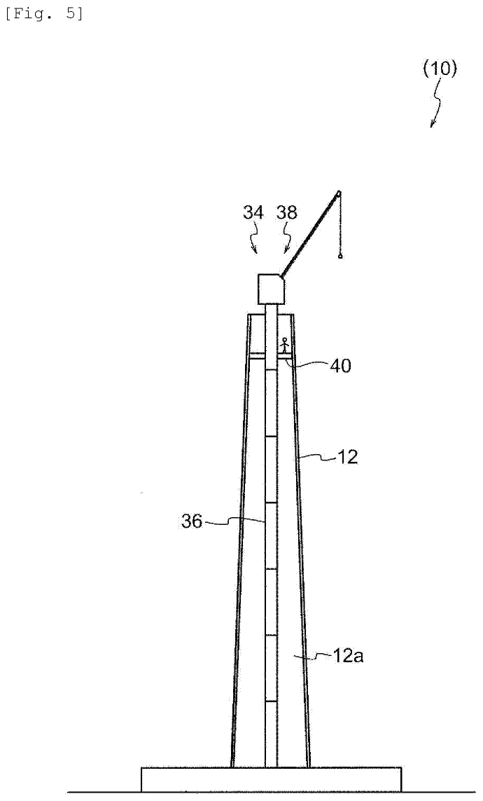

FIG. 5 shows a state where the disassembling of the structure objects of the wind power generator 14 including the nacelle 18 is completed, and schematically shows the inner state of the tower body 12. After the disassembling of the wind power generator 14 is completed, it is then needed to disassemble the tower body 12 itself but the inner hollow 12a of the tower body 12 does not have a place where a person gets on and works. Therefore, in the method for disassembling a tower-type wind power generation facility of this embodiment, the stage 40 which persons can get on is provided on the inner tower 36 for the tower crane apparatus 34 (working stage installing step). As exemplarily shown in FIG. 6, this stage 40 has a circular plate shape spreading in the horizontal direction on the periphery of the inner tower 36, and is provided below the crane apparatus 38. A lift apparatus 42 is provided beneath on this stage 40, for the stage 40 being lifted and lowered along the inner tower 36. This lift apparatus 42 also has a function of fixing the stage 40 to the inner tower 36 at a desired height. Specifically, it has the similar configuration to that of the lift apparatus of the mast climbing-type tower crane 34. Notably, the stage 40 may be installed in any stage after building the inner tower 36, which is not limited to this stage.

Moreover, roller apparatuses 44 are provided on the lower surface of this circular plate-shaped stage 40 at the peripheral edge part thereof, for balancing the stage 40 in the inner hollow 12a of the tower body 12. This roller apparatus 44 is configured to include a plurality of rollers 46 which can rotate along the inner wall surface of the tower body 12 in the up-down direction, arms 48 which rotatably support these respective rollers 46 and are coupled onto the lower surface of the stage 40, and springs 50 which press the rollers 46 onto the inner wall surface of the tower body 12 via the arms 48. These roller apparatuses 44 are arranged on the peripheral edge part of the lower surface of the circular plate-shaped stage 40 at the same intervals, and each rollers 46 are pressed onto the inner wall surface of the tower body 12 with the springs 50 at equivalent pressing force. Therefore, the stage 40 is stabilized to be well balanced in the inner hollow 12a of the tower body 12. Moreover, such a configuration achieves a structure in which the stage 40 supports the inner tower 36 against the wall surface of the inner hollow 12a of the tower body 12.

Moreover, step treads 54 which can be caused to protrude outward in the radial direction of the stage 40 are arranged on the peripheral edge part of the upper surface of this circular plate-shaped stage 40 via hinges 52 at the same intervals in the circumferential direction of the stage 40. As exemplarily shown in FIG. 5, the tower body 12 has a truncated cone shape the lower part of which is thick and the upper part of which is thin, and the inner hollow 12a also has a truncated cone-shaped space the lower part of which is wide and the upper part of which is narrow. A reducing rate (expanding rate) of this inner hollow 12a in the height direction is about 1 cm in radius per 1 m in height of the tower body 12. For example, when the height of the tower body 12 is 60 m and the outer diameter of the circular plate-shaped stage 40 is caused to meet the inner diameter of the inner hollow 12a at the uppermost part of the tower body 12, the gap between the peripheral edge part of the stage 40 and the inner wall surface of the tower body 12 expands up to about 60 cm when the stage 40 is lowered to the lowermost part of the tower body 12. In such a case, the step treads 54 are caused to protrude outward in the radial direction of the stage 40 by the hinges 52 being rotated. Then, persons can get on the step treads 54 to perform disassembling work of the tower body 12. Notably, the step treads 54 may be configured to slide outward of the stage 40 in the radial direction or employ the similar configuration.

Moreover, in this embodiment, as indicated by the two-dot chain line in FIG. 6, a roof 56 can be provided on the inner tower 36 above the stage 40 (roof installing step). This roof 56 has a circular plate shape to cover the stage 40, and is installed inside the tower body 12. Since providing the roof 56 inside the tower body 12 above the stage 40 as above can afford a shelter from rain (snow), disassembling work of the tower body 12 can be performed even in rainy weather after the nacelle 18 is removed.

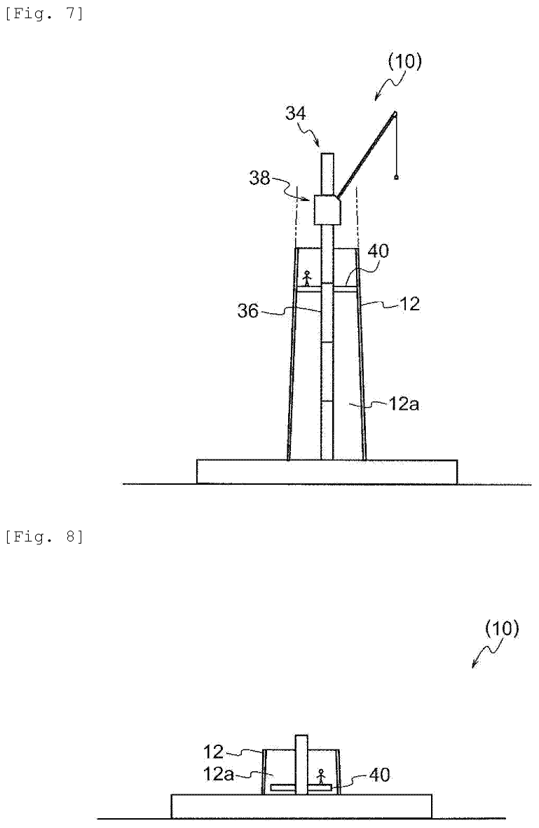

Since a staircase (ladder) is generally provided on the inner tower 36 built for the tower crane 34 such that persons can climb and descend the same, persons can climb this not-shown staircase (ladder) up to the stage 40, get on the stage 40, and disassemble the tower body 12 via the inner hollow 12a. Disassembled objects resulting from disassembling the tower body 12 can be lowered using the crane apparatus 38 at the upper end part of the inner tower 36. The tower body 12 is disassembled sequentially from its upper portion, and the disassembled objects are lowered through the outside of the tower body 12 using the crane apparatus 38 at the upper end part of the inner tower 36 (tower body disassembling step). As shown in FIG. 7, the stage 40 is lowered stepwise in accordance with disassembling the tower body 12, the tower body 12 is disassembled at the position (height), the disassembled objects are lowered through the outside of the tower body 12 with the crane apparatus 38. Moreover, the inner tower 36 may be disassembled from the upper portion in accordance with the disassembling position (height) being lowered, the disassembled inner tower members being lowered with the crane apparatus 38.

FIG. 8 shows a state of the final stage of the essential part in disassembling operation of the tower-type wind power generation facility 10, and schematically shows the inside of the tower body 12. As mentioned above, after the tower body 12 is sequentially disassembled from its upper portion, the disassembled objects are lowered with the crane apparatus 38 at the upper end part of the inner tower 36, and the disassembling position (height) is lowered stepwise, as shown in FIG. 7, some disassembled objects of the tower body 12 become able to be lowered without using the crane apparatus. After the tower body 12 is disassembled, and then, after the crane apparatus 38 and the stage 40 are removed, inner tower members at the lower end part of the inner tower 36 are removed to complete the essential part in disassembling operation.

As mentioned above, in conventional disassembling operation of a tower-type wind power generation facility, scaffolding is set up on the whole periphery outside the tower body, and the tower body and the like are disassembled using the scaffolding. Setting up the scaffolding on the whole periphery outside the tower body, which is a huge structure with 60 m or more of height, however needs much labor and time due to the huge scaffolding itself even if it is semi-automated. Moreover, since sites where wind power generation facilities are constructed typically have strong wind, this makes it much more difficult to set up scaffolding. Since in the method for disassembling a tower-type wind power generation facility of this embodiment, huge scaffolding does not need to set up on the whole periphery outside the huge tower body 12, the period of disassembling operation can be reduced and the steps of the disassembling operation can be simplified. Moreover, since the tower body 12 can be disassembled from its inside on the stage 40, wind scarcely affects the disassembling work. Moreover, since in a conventional method for disassembling a tower-type wind power generation facility, disassembled objects need to be lowered using a crane built on the scaffolding or a movable crane, this leads to extra labor and costs. On the contrary, since in the method for disassembling a tower-type wind power generation facility of this embodiment, disassembled objects can be lowered through the outside of the tower body 12 using the crane apparatus 38 provided at the upper end part of the inner tower 36, these can reduce the labor and costs of the disassembling operation.

Since in the method for disassembling a tower-type wind power generation facility of this embodiment, as above, the tower crane 34 can be built in the inner hollow 12a of the tower body 12, the structure objects of the wind power generator 14 including the nacelle 18 at the upper end part of the tower body 12 can be disassembled, the disassembled objects can be lowered through the outside of the tower body 12 using the crane apparatus 38 of the tower crane 34, the tower body 12 can be disassembled, after the wind power generator 14 is disassembled, from its inside via the stage 40 provided on the inner tower 36, and the disassembled objects can be lowered through the outside of the tower body 12 using the crane apparatus 38 of the tower crane 34, huge scaffolding does not need to be set up on the whole periphery outside the huge tower body 12. Moreover, since lifting and lowering the stage 40 makes the disassembling work of the tower body dramatically easy, this can reduce the period of the disassembling operation of the tower-type wind power generation facility 10 and can simplify the disassembling operation itself, which can consequently reduce costs of the disassembling operation of the tower-type wind power generation facility 10 as a whole. Moreover, even for an off land tower-type wind power generation facility 10 or the like that sufficient scaffolding cannot be set up on the periphery of the tower body 12 of, disassembling operation can be securely performed using the tower crane 34 built in the inner hollow 12a.

Moreover, by lifting and lowering the stage 40 along the inner tower 36 in accordance with the disassembling position of the tower body 12, persons on the stage 40 can disassemble the tower body 12 safely and efficiently.

Moreover, since the stage 40 spreads in the horizontal direction on the periphery of the inner tower 36 in the inner hollow 12a of the tower body 12 and includes a lift facility for the stage 40 being lifted and lowered along the inner tower 36, persons on the stage 40 can disassemble the tower body 12 at various places at the same height, and therefore, by lifting and lowering this stage 40 with the lift apparatus, the tower body 12 can be disassembled sequentially from its upper portion.

Moreover, providing the roof 56 on the inner tower 36 between the crane apparatus 38 and the stage 40 can afford a shelter from rain (snow) onto the stage 40, and thereby, the disassembling operation of the tower-type wind power generation facility 10 can be performed even in rainy weather or the like.

Moreover, by opening the nacelle 18 provided at the upper end part of the tower body 12 to penetrate in the up-down direction prior to building the inner tower 36, the inner tower 36 can be built to penetrate the tower body 12 to the upper portion.

Moreover, by forming the opening part 32 for carrying facilities in in the lower end part of the tower body 12 prior to building the inner tower 36, the inner tower members and the crane apparatus 38 can be carried in through the opening part 32 for carrying facilities in, and thereby, the inner tower 36 can be easily built in the tower body 12 and the crane apparatus 38 can be easily installed (moved) onto the upper part of the inner tower 36.

Moreover, by employing the mast climbing-type crane apparatus 38 which climbs or descends the inner tower 36 along the same while building or disassembling the inner tower 36, the inner tower 36 can be easily and securely built in the tower body 12 and the crane apparatus 38 can be easily and securely moved onto the upper part of the inner tower 36.

Notably, while in the aforementioned embodiment, the mast climbing-type crane apparatus 38 is used for the tower crane 34, for example, the inner tower 36 may be built up to the upper end part, and then, the crane apparatus 38 may be mounted onto the uppermost part.

It is needless to say that the present invention includes various embodiments and the like that are not mentioned above. It is accordingly understood that the technical scope of the present invention is defined only by the matters specifying the invention which are cited in the claims and regarded as appropriate based on the description above.

### REFERENCE SIGNS LIST

10 Tower-type wind power generation facility
12 Tower body
14 Wind power generator
16 Rotor
18 Nacelle
32 Opening part
34 Tower crane
36 Inner tower
38 Crane apparatus
40 Stage
42 Lift apparatus
56 Roof

1. A method for disassembling a tower-type wind power generation facility including a tower body having an inner hollow communicating in an up-down direction, and a wind power generator provided at an upper end part of the tower body, the method comprising:
an inner tower building step of building, in the inner hollow of the tower body, an inner tower that penetrates from a region of a lower end part of the tower body to an upper portion of the power generation facility and that a crane apparatus is able to be mounted on;
a crane installing step of installing the crane apparatus on the inner tower;
a wind power generator disassembling step of disassembling a structure object of the wind power generator at the upper end part of the tower body to lower a resulting disassembled object through an outside of the tower body with the crane apparatus;
a working stage installing step of providing, in midterm of or after the steps, a stage for disassembling work on the inner tower; and
a tower body disassembling step of disassembling the tower body using the stage sequentially from its upper part to lower a resulting disassembled object through the outside of the tower body with the crane apparatus.

2. The method for disassembling a tower-type wind power generation facility according to claim 1, wherein the installation of the stage in the working stage installing step is performed such that the stage extends in a horizontal direction on a periphery of the inner tower in the inner hollow of the tower body and is performed such that the stage is able to be lifted and lowered along the inner tower.

3. The method for disassembling a tower-type wind power generation facility according to claim 2, wherein the working stage installing step includes adjusting a height position of the stage by the stage being lifted or lowered so as to meet a disassembling position in the tower body disassembling step.

4. The method for disassembling a tower-type wind power generation facility according to claim 1, comprising a roof installing step of providing a roof on the inner tower between the crane apparatus and the stage.

5. The method for disassembling a tower-type wind power generation facility according to claim 1, comprising, before the inner tower building step, a tower body upper part opening step of opening a wind power generator housing part at an upper end part of the tower body to penetrate in the up-down direction.

6. The method for disassembling a tower-type wind power generation facility according to claim 1, comprising, before the inner tower building step, an opening part forming step of forming an opening part for carrying a facility in in a lower end part of the tower body.

7. The method for disassembling a tower-type wind power generation facility according to claim 1, wherein the inner tower building step and the crane installing step are performed using a mast climbing-type crane apparatus that climbs and descends the inner tower along the same while building the inner tower.

8. The method for disassembling a tower-type wind power generation facility according to claim 2, comprising a roof installing step of providing a roof on the inner tower between the crane apparatus and the stage.

9. The method for disassembling a tower-type wind power generation facility according to claim 3, comprising a roof installing step of providing a roof on the inner tower between the crane apparatus and the stage.

10. The method for disassembling a tower-type wind power generation facility according to claim 2, comprising, before the inner tower building step, a tower body upper part opening step of opening a wind power generator housing part at an upper end part of the tower body to penetrate in the up-down direction.

11. The method for disassembling a tower-type wind power generation facility according to claim 3, comprising, before the inner tower building step, a tower body upper part opening step of opening a wind power generator housing part at an upper end part of the tower body to penetrate in the up-down direction.

12. The method for disassembling a tower-type wind power generation facility according to claim 4, comprising, before the inner tower building step, a tower body upper part opening step of opening a wind power generator housing part at an upper end part of the tower body to penetrate in the up-down direction.

13. The method for disassembling a tower-type wind power generation facility according to claim 2, comprising, before the inner tower building step, an opening part forming step of forming an opening part for carrying a facility in in a lower end part of the tower body.

14. The method for disassembling a tower-type wind power generation facility according to claim 3, comprising, before the inner tower building step, an opening part forming step of forming an opening part for carrying a facility in in a lower end part of the tower body.

15. The method for disassembling a tower-type wind power generation facility according to claim 4, comprising, before the inner tower building step, an opening part forming step of forming an opening part for carrying a facility in in a lower end part of the tower body.

16. The method for disassembling a tower-type wind power generation facility according to claim 5, comprising, before the inner tower building step, an opening part forming step of forming an opening part for carrying a facility in in a lower end part of the tower body.

17. The method for disassembling a tower-type wind power generation facility according to claim 2, wherein the inner tower building step and the crane installing step are performed using a mast climbing-type crane apparatus that climbs and descends the inner tower along the same while building the inner tower.

18. The method for disassembling a tower-type wind power generation facility according to claim 3, wherein the inner tower building step and the crane installing step are performed using a mast climbing-type crane apparatus that climbs and descends the inner tower along the same while building the inner tower.

19. The method for disassembling a tower-type wind power generation facility according to claim 4, wherein the inner tower building step and the crane installing step are performed using a mast climbing-type crane apparatus that climbs and descends the inner tower along the same while building the inner tower.

20. The method for disassembling a tower-type wind power generation facility according to claim 5, wherein the inner tower building step and the crane installing step are performed using a mast climbing-type crane apparatus that climbs and descends the inner tower along the same while building the inner tower.
